(19) United States
(12) Patent Application Publication
(10) Pub. No.: US 2025/0243989 A1
(43) Pub. Date: Jul. 31, 2025

(54) LIGHTING FIXTURE

(71) Applicant: ABL IP Holding, LLC, Atlanta, GA (US)

(72) Inventors: Carl GOULD, Golden, CO (US); Christopher Jay SORENSEN, Arvada, CO (US); Zachary Adam INGALLS, Littleton, CO (US); Kevin Leadford, Evergreen, CO (US)

(21) Appl. No.: 19/040,436

(22) Filed: Jan. 29, 2025

Related U.S. Application Data
(60) Provisional application No. 63/626,138, filed on Jan. 29, 2024.

(51) Int. Cl. F21V 5/08; F21V 3/00; F21W 131/107; F21Y 105/18; F21Y 113/13; F21Y 115/10

(52) U.S. Cl. CPC F21V 5/08; F21V 3/00; F21W 2131/107; F21Y 2105/18; F21Y 2113/13; F21Y 2115/10

(57) ABSTRACT

The present disclosure provides a lighting fixture to illuminate a surface. The lighting fixture includes a first light source configured to generate a first selected light color output; and a second light source configured to generate a second selected light color output; wherein the first light source and the second light source are disposed adjacent to one another; and wherein the first light source to project the first selected light color output towards a first region of the surface and the second light source to project the second selected light color output towards a second region of the surface; and wherein a first peak intensity of the first light source and a second peak intensity of the second light source angled with respect to one another to produce a selected color gradient on the surface.

### CROSS REFERENCE TO RELATED APPLICATIONS

The present application claims the benefit of U.S. Provisional Application Ser. No. 60/626,138, filed Jan. 29, 2024, which is hereby incorporated by reference in its entirety.

### TECHNICAL FIELD

The present disclosure is generally directed to a lighting fixture, and, more particularly, to a façade lighting fixture for exterior or interior lighting applications.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A illustrates an example of the lighting effects of a lighting fixture according to one embodiment of the present disclosure;

FIG. 1B illustrates an example of the lighting effects of a lighting fixture according to another embodiment of the present disclosure;

FIGS. 2A-2D illustrate various views of a lighting fixture consistent with one embodiment of the present disclosure;

FIG. 3 illustrates a lighting fixture arrangement consistent with another embodiment of the present disclosure;

FIGS. 4A and 4B illustrate a lighting fixture consistent with another embodiment of the present disclosure;

FIGS. 5A and 5B illustrate intensity distribution plots consistent with embodiments of the present disclosure;

FIG. 6 illustrates a plot of a color gradient curve consistent with embodiments of the present disclosure;

FIGS. 7A-7F illustrate a lighting fixture consistent with another embodiment of the present disclosure;

FIG. 8 is a plot of approximate fixture aiming angle as a function of wall height according to embodiments of the present disclosure;

FIG. 9 illustrates a lighting fixture consistent with another embodiment of the present disclosure;

FIG. 10 illustrates a lighting fixture consistent with another embodiment of the present disclosure; and

FIG. 11 illustrates a lighting fixture consistent with another embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure provides lighting fixtures to illuminate a surface (typically a wall/facade) or object (e.g. a column) with a smooth, two or more color, gradient from a single fixture, or array of fixtures, that would typically be either ground/floor mounted or ceiling/top-of-wall mounted. In the embodiments described herein, the gradient lighting effect is directionally linear. For example, in embodiments where a lighting fixture according to the teachings provided herein, is ground-mounted (pointed generally upwards) or ceiling mounted (pointed generally downwards), the gradient lighting effect is directionally linear from top to bottom on a projection surface, such that any horizontal line on the projection surface has substantially the same hue of blended colors.

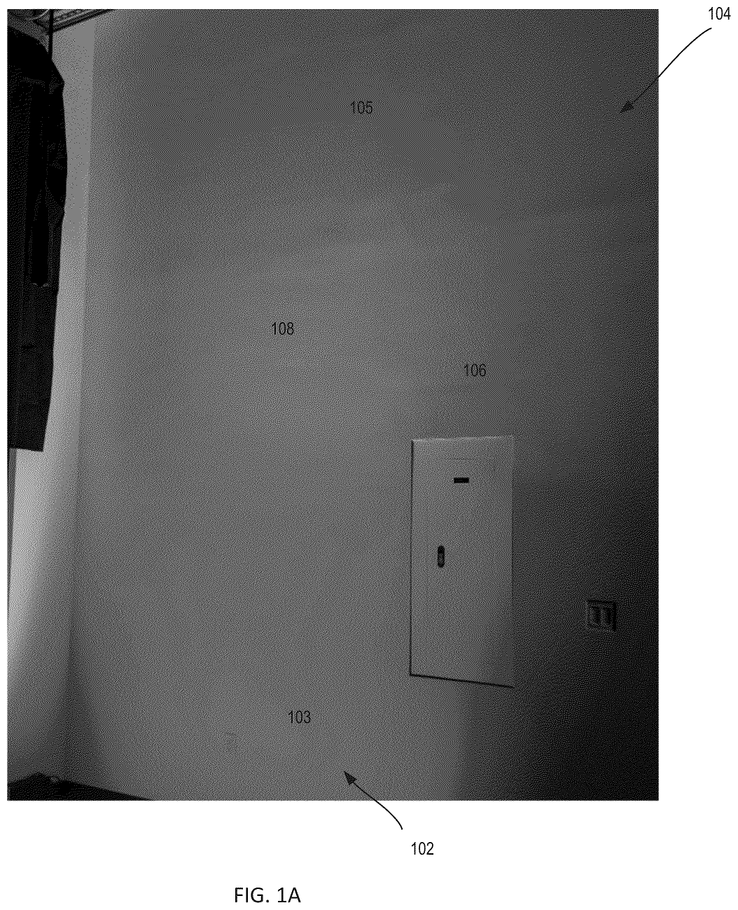

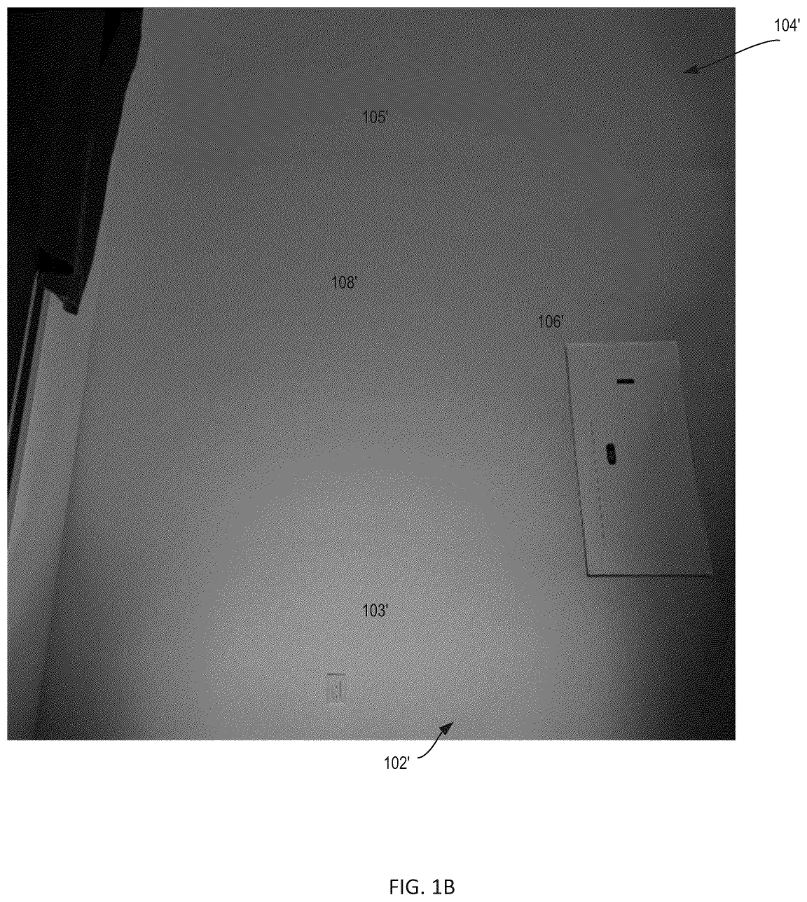

FIG. 1A illustrates an example of the lighting effects of a lighting fixture according to one embodiment of the present disclosure. As shown in FIG. 1A, the lighting fixture (described in greater detail below) is configured to project two light colors 102 and 104 onto a surface 106 (in this example, the surface 106 is an interior wall). In this example, a blue light 102 (lower) and a green light 104 (upper) are projected onto the wall 106 so that the lighting effect produces a smooth, directionally linear color gradient with a transition region 108 between an area 103 that predominately consists of the blue light 102 and an area 105 that predominately consists of the green light 104, thus providing a smooth and gradual transition between the lights, as perceived on the surface 106.

FIG. 1B illustrates an example of the lighting effects of a lighting fixture according to another embodiment of the present disclosure. As shown in FIG. 1B, the lighting fixture (described in greater detail below) includes a linear array of lighting sources to project two light colors 102′ (magenta) and 104′ (blue) onto a surface 106′ (in this example, the surface 106′ is an interior wall) in a repeated fashion horizontally across the surface 106′. In this example, the lighting effect produces a smooth, linear color gradient (top to bottom) in transition region 108′ between an intensity area 103′ of the magenta light 102′ and an intensity area 105′ of the predominantly blue light 104′, thus providing gradual transition between the lights, as perceived on the surface 106′.

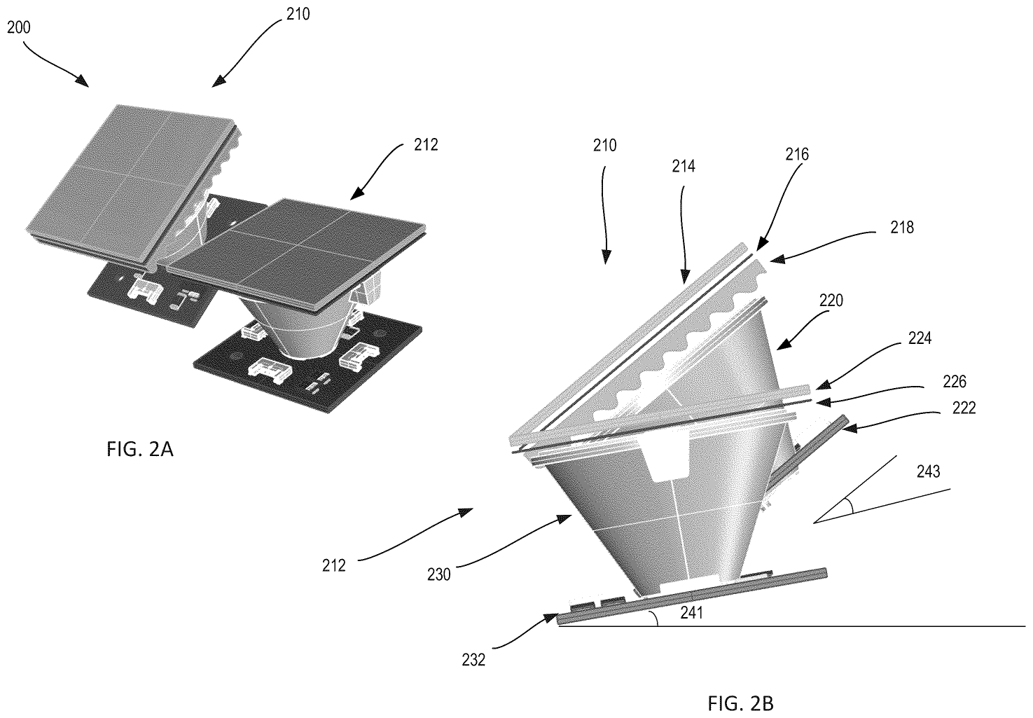

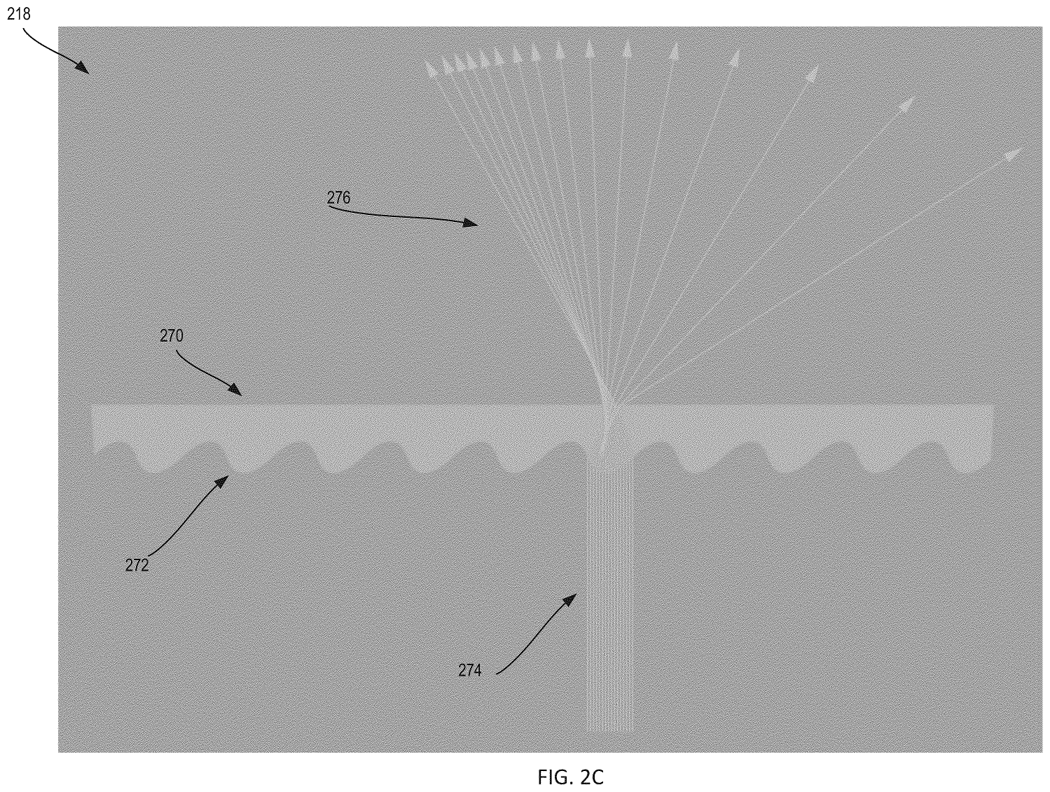

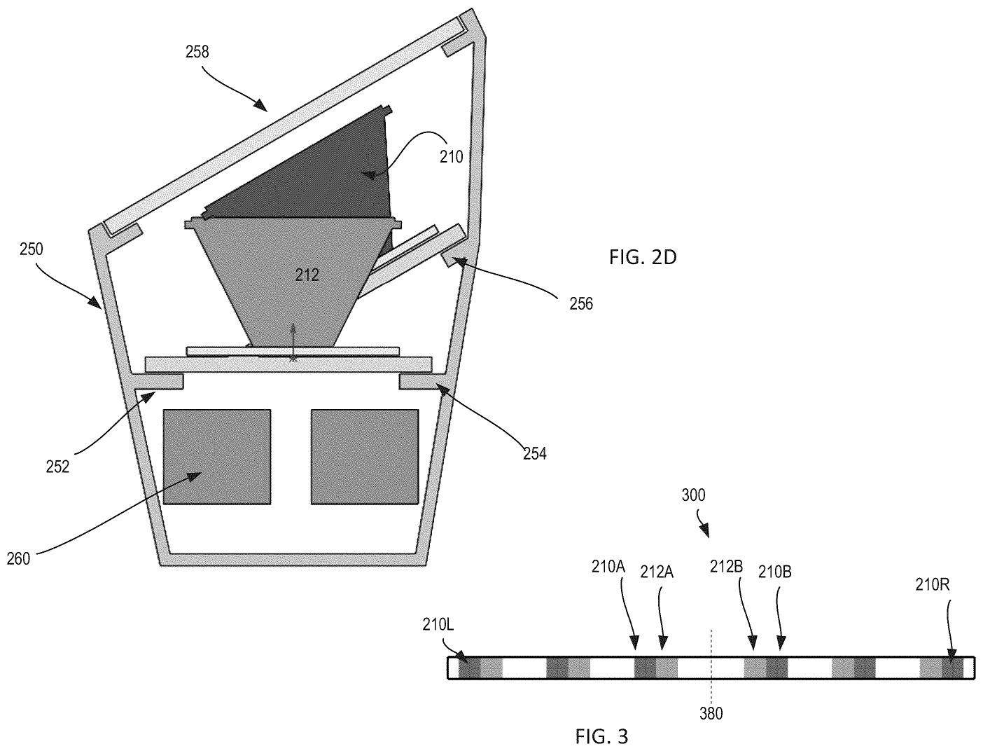

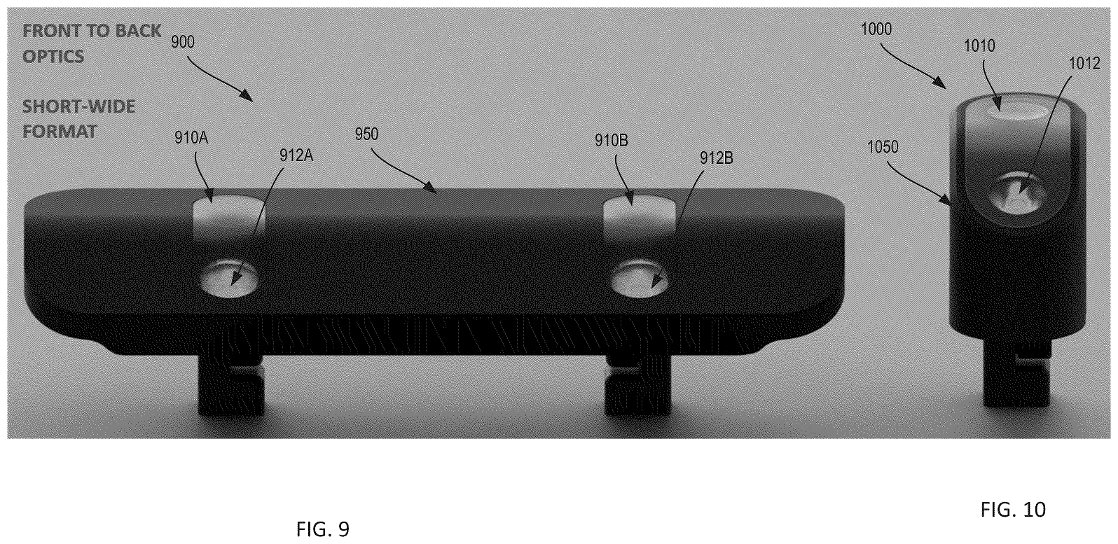

FIGS. 2A and 2B illustrate a lighting fixture 200 consistent with one embodiment of the present disclosure. The lighting fixture 200 includes a first light source 210 generally configured to generate a first selected light color output (or color temperature output in the case of nominally “white” light), and a second light source 212 configured to generate a second selected light color output (or color temperature output in the case of nominally “white” light). The first light source 210 is “aimed” at a first region of a surface, e.g., a bottom region of a projection surface (e.g, wall, column, etc.). The second light source 212 is “aimed” at a second region of the projection surface, e.g., a top region of the wall, column, etc. As shown in FIG. 2B, the second light source 212 has a physical angle 241 with respect to a ground plane (or ceiling plane, or other reference plane) that is a function of (based on) a wall/column height, offset of the lighting fixture 200 away from the wall/column, etc. as described below with reference to FIG. 9. The angle 241 may be applied to the entire lighting fixture 200.

A color gradient is formed on the surface based on an angle 243 between the first and second light sources 210, 212, which is a function of the intensity distribution of the light sources 210, 212, and angle 241 which is a function of a distance the light sources 210,212 are from the projection surface, and the expanse of the projection surface (e.g., wall/column height), as will be described herein.

FIG. 2B illustrates the lighting fixture 200 in more detail. The first light source 210 includes a base unit 222 that generally includes electronic components to drive a lighting element (not shown) and may be formed of, for example, PCB material, etc. The lighting element may include any known or after-developed lighting element, for example, RGB, RGBW, and RGBA type LED or clusters of LEDs, etc. The first light source 210 may also include a collimator 220 (e.g., color mixing collimator) generally configured to direct light from a lighting element toward the front of the cone 220 into a narrow beam. The first light source 210 may also include other components to shape a light intensity and/or light direction of the light source. In one example embodiment, the first light source 210 may include an asymmetric refractor 218 disposed over the collimator 220. The asymmetric refractor 218 is generally configured to convert a narrow symmetric light beam generated by the lighting element and the collimator into a broad asymmetric light beam projected onto the bottom of the surface. The asymmetric refractor 218 may be formed of glass, plastic, etc., and may also be in a film format with micro features or formed (e.g. via injection molding or extrusion) with macro features.

FIG. 2C illustrates a cross-sectional view of an example asymmetric refractor 218 according to one embodiment. The refractor 218 has a generally smooth surface 270 and an opposing scalloped surface 272 to convert a narrow symmetric light beam 274 generated by the lighting element and the collimator into a broad asymmetric light beam 276 projected predominately onto a closer region of the surface (onto the bottom of the surface when the lighting fixture is ground-mounted). In other embodiments, the optical function of the asymmetric refractor 218 could alternatively be integrally designed into a single optic structure combining the asymmetric refractor 218 and the collimator 220 into a single optics package, rather than being a separate structure.

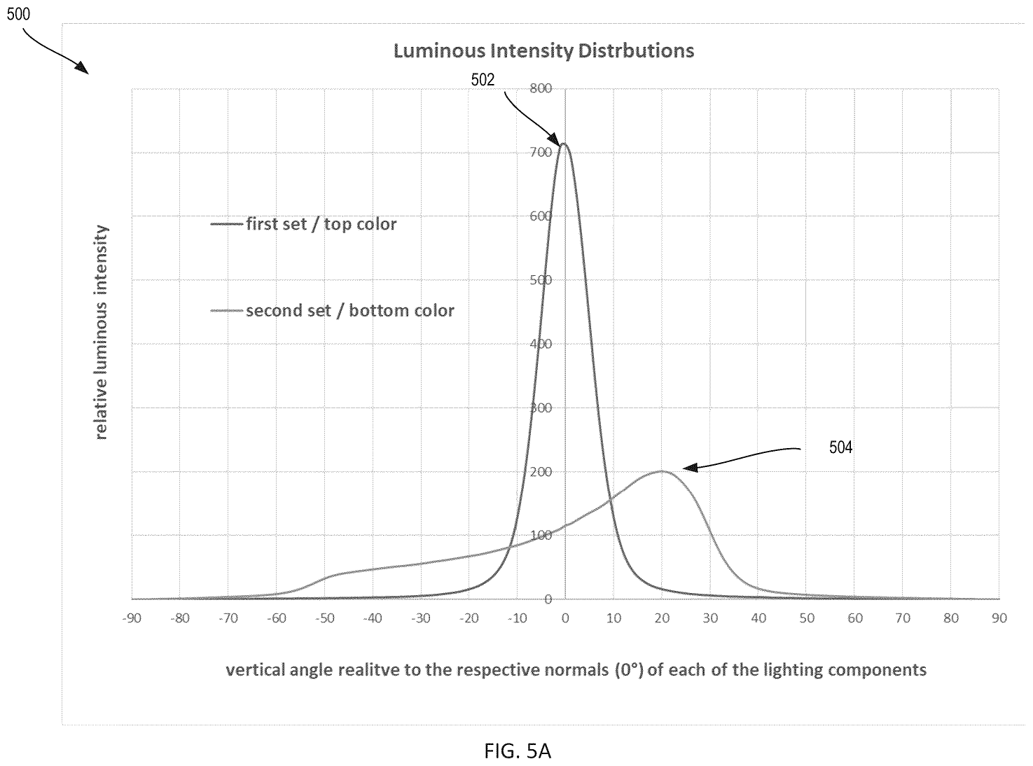

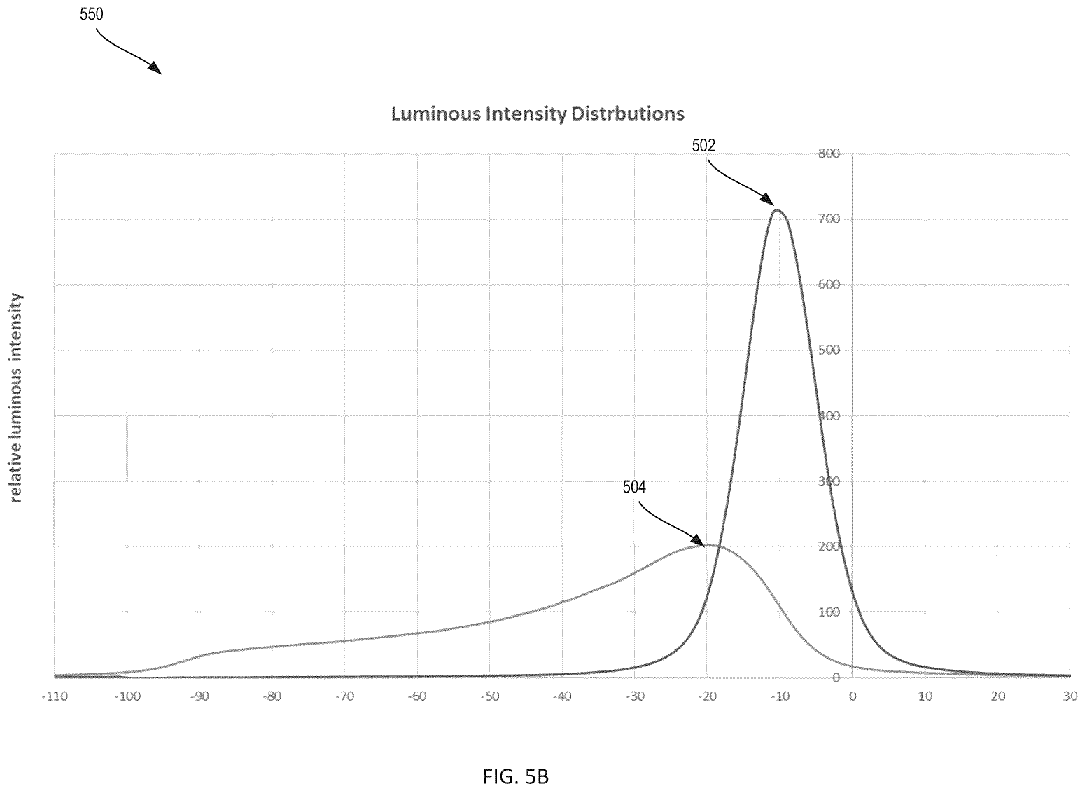

Referring briefly to FIGS. 5A and 5B, the optical effect of the refractor 218 is shown in the bottom curve which represents intensity in a plane perpendicular to the projection surface and passing through the lighting fixture containing the light sources, the light distribution of light source 210 is characterized by a peak intensity 504 offset toward one end of the distribution, a steep fall-off at that near end and a long Gaussian-like “tale” on the other side of the peak intensity.

The first light source 210 may also include an elliptical diffuser 216 disposed over the refractor 218. The diffuser 216 is generally configured to “spread” the light beam left-to-right (i.e., horizontally) along the surface. In some embodiments, the diffuser 216 may provide light diffusion that is asymmetric or ovular. In some embodiments, the elliptical diffusion films 216 may have a diffusion pattern that is narrow in a vertical axis and broad in a horizontal axis, for example a 1:40 ratio of angular diffusion. The diffuser 216 may be embodied, for example, as a diffusion film with micro-features, optical unit formed of plastic/glass, etc., as is known. The first light source 210 may also include a cover lens (e.g., formed of glass, plastic, etc.) 214 disposed over the elliptical diffuser 216. The first light source 210 may also include a cover lens (e.g., formed of glass, plastic, etc.) 214 disposed over the elliptical diffuser 216.

The second light source 212 may be similarly configured as the first light source 210, except that, in some embodiments, the asymmetric refractor may be omitted since the light source 212 is aimed at a region on the surface that is further away than the projected first light source. A physical angle 243 between the first light source 210 and the second light source 212 may be selected to provide a smooth color gradient between the light sources. The second light source 212 may also include elliptical diffuser 226, similar to diffuser 216, described above. In one embodiment, a physical angle 243 of approximately 30 degrees between the first light source 210 and the second light source 212 generates a desirable color gradient between the light sources Of course, in other embodiments, the physical angle 241 between the light sources 210/212 may be selected to achieve a desired gradient lighting effect and may be based on, for example, a distance the light sources 210,212 are from the projection surface (e.g., light sources that are closer to the projection surface may require a greater physical angle between them to generate a desired/desirable gradient lighting effect, compared to light sources that are further away from the projection surface), and the intensity distributions of the light sources 210, 212. The light sources 210 and 212 are depicted in FIGS. 2A and 2B as being in a horizontal “side-by-side” arrangement, and may be adapted for indoor use and/or outdoor use.

FIG. 2D illustrates a cross-sectional view of the lighting fixture 200. The first and second light sources 210 and 212 may be disposed in a housing 250. The housing 250 may include internal support structures 252, 254, 256 to support the first the first and second light sources 210 and 212, as illustrated, i.e, supporting the first and second light sources 210 and 212 to have a selected offset angle 243 (described above, e.g., approximately 30 degrees, depending on the wall/column height and distance of the lighting fixture 200 from the target wall/column, etc.) to generate the desired linear gradient lighting effect as described herein. A protective cover lens 258 (e.g., single aperture lens) may be disposed over the first and second light sources 210, 212, and the lens may be scaled to the housing 250 to provide moisture resistance for the light sources. Driver circuitry 260 may be disposed within the housing 250 to drive the electronic components associated with the lighting elements of the first and second light sources 210, 212. The housing 250 may be “tilted” to produce angle 241 in reference to the ground plane.

FIG. 3 illustrates an overview arrangement of a lighting fixture 300 consistent with another embodiment of the present disclosure. The lighting fixture 300 of this embodiment generally includes a linear array of a plurality of the first and second light sources 210, 212 described above. As illustrated, the linear array of this example is formed using 6 pairs of the first and second light sources 210 and 212. Based on the number of pairs of light sources used for a given application, a centerline 380 is determined. The pairs of light sources 210 and 212 are disposed in a mirrored arrangement about the centerline 380. Thus, for example, a first pair 210A/212A is disposed to the left of the centerline 380, where the second light source 212A is closest to the centerline 380. A second pair 210B/212B is disposed to the right of the centerline 380, where the second light source 212B is closest to the centerline 380. This arrangement ensures that the leftmost light source 210L and the rightmost light source 210R are at either end of the linear arrangement. Such an arrangement may enhance nearfield left-to-right symmetry of the projected color gradient.

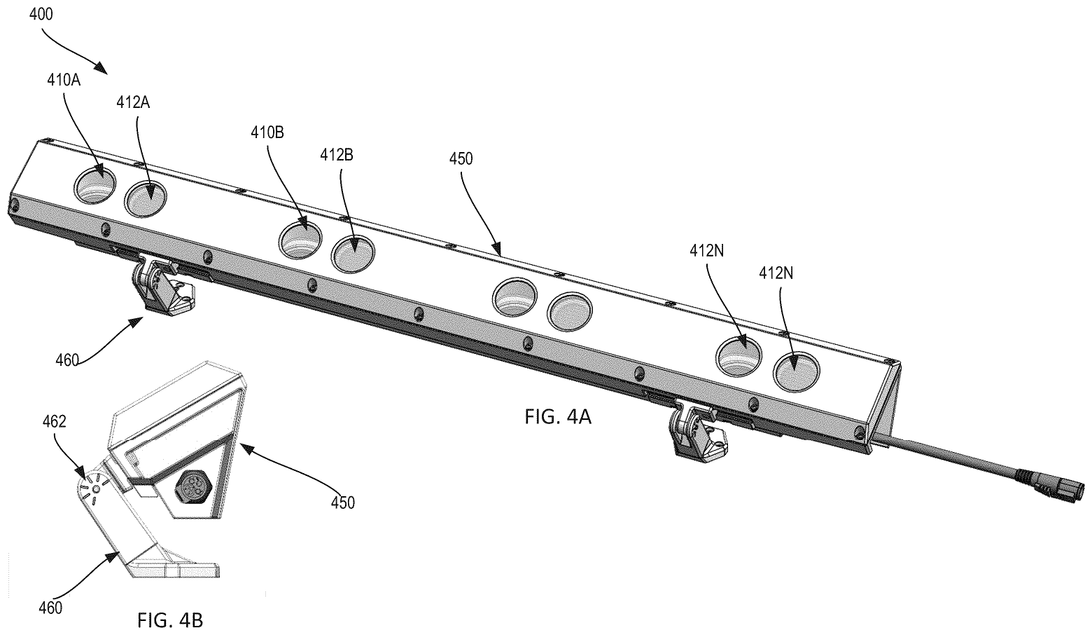

FIGS. 4A and 4B illustrate a lighting structure 400 consistent with another embodiment of the present disclosure. In this embodiment, a linear arrangement of first and second light source pairs 410A/412A, 410B/412B, . . . , 410N/412N the first light source 410 and second light source 412 are disposed within elongated housing 450. The features of the first and second light source pairs 410A/412A, 410B/412B, . . . , 410N/412N are similar to the light sources 210 and 212, as described above. The housing 450 may be pivotally mounted to one or more foot members 460, which may be affixed, for example to a ground surface, ceiling surface, etc. The housing 250 may pivot with respect to the foot members 460 to provide the angle 241, described above with reference to FIG. 2A. FIG. 4B is a side view of the lighting structure 400, and illustrates the foot member 460 and the housing member 450 that is pivotally coupled to the foot member 460 at the pivot region 462.

FIG. 5A illustrates an intensity distribution plot 500 consistent with embodiments of the present disclosure. The intensity distributions are illustrated in a plane perpendicular to the projection surface and passing through the light source. As illustrated, the intensity of the top light source (212 in FIGS. 2A-2C; 412 in FIG. 4A) is configured to have a narrow beam such that the intensity is concentrated in a narrow vertical angle range, for example, less than a 25 degree beam as measured using a full-width, half max (FWHM) metric, for example, a 10 degree beam. The intensity of the bottom light source (210 in FIGS. 2A-2C; 410 in FIG. 4A) is configured to have a fairly broad and asymmetric beam such that the intensity is spread across a wider vertical angle range, for example, 50 degrees or greater as measured using a full width tenth max (FWTM) metric. Referring again to FIG. 2B, it should be noted that the physical angle 243 between the two sources may be different than an angle between their respective peak intensities. This concept is illustrated in FIG. 5A as the “shift” of peak intensities between the first source 210/410 and the second source 212/412, In particular, where 0 degrees represents a peak intensity 502 of the first source that is normal to, for example, a plane of an output face of the collimator of the first source, and the peak intensity 504 of the second source is approximately 20 degrees off of normal of the output face of the collimator of the second source. FIG. 5B illustrates an intensity distribution plot 550 consistent with embodiments of the present disclosure. The intensity distributions are again illustrated in a plane perpendicular to the projection surface and passing through the light source, however the plots now show the relative peak intensities of the sources when arranged as a fixture as shown, for example in FIG. 2D and FIG. 4A. In particular, in FIG. 5B, the left shift of peak intensities 502/504 compared to FIG. 5A are a result of the physical angle 243 between the light sources and the “global” angle 241 (relative to, for example, the ground plane) of the lighting fixture as a whole. As shown in FIG. 5B, the separation (i.e., angle) between the peak intensities 502/504 is approximately 10 degrees in this example. The inventors herein have determined that an angle between the peak intensities of between 5 and 25 degrees (inclusive) provides a visually pleasing gradient effect.

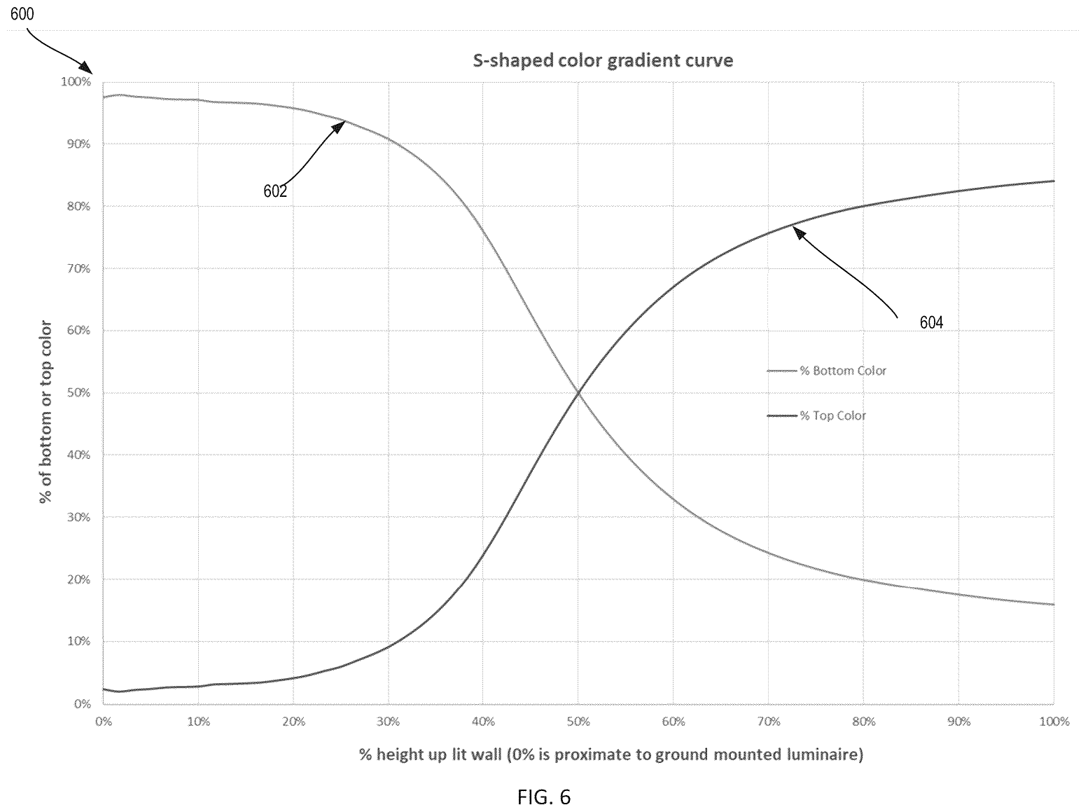

FIG. 6 illustrates a plot 600 of color gradient curves consistent with embodiments of the present disclosure. The x-axis represents a position on the projection surface along the direction of the color gradient (e.g. height up a wall expressed as a percentage of the total wall height). The y-axis represents the percentage of total light (from both light sources) at a given height coming from the first or second light source. that Curve 602 is the percentage of r total light coming from the light source with the broad asymmetric distribution (i.e., the light source that predominantly lights the proximate portion of the surface (e.g. light source 210 generally directed to the bottom region of a wall for a ground-mounted application). Similarly, curve 604 is the percentage of total light coming from the light source with the narrow distribution (i.e., the light source that predominantly lights the distal portion of the surface (e.g. light source 212 generally directed to the top region of the wall for a ground-mounted application). Each of these curves are generally S-shaped, as shown. The “S-shaped” color gradient curves shown in FIG. 6 are a result of the intensity distribution plots shown in FIG. 5B, which is a result of the physical angle 243 between the light sources, the optical effect of the refractor 218 of the bottom light source which is characterized by a peak intensity offset toward one end of the distribution, a steep fall-off at that near end and a long Gaussian-like “tale” on the other side of the peak intensity, and the narrower intensity distribution of the top light source. The inventors herein have determined that, as defined above, a color gradient that is generally S-shaped is visually pleasing, since both colors are well-represented at the top and bottom of the surface, respectively, and there is a smooth transition between them in the middle.

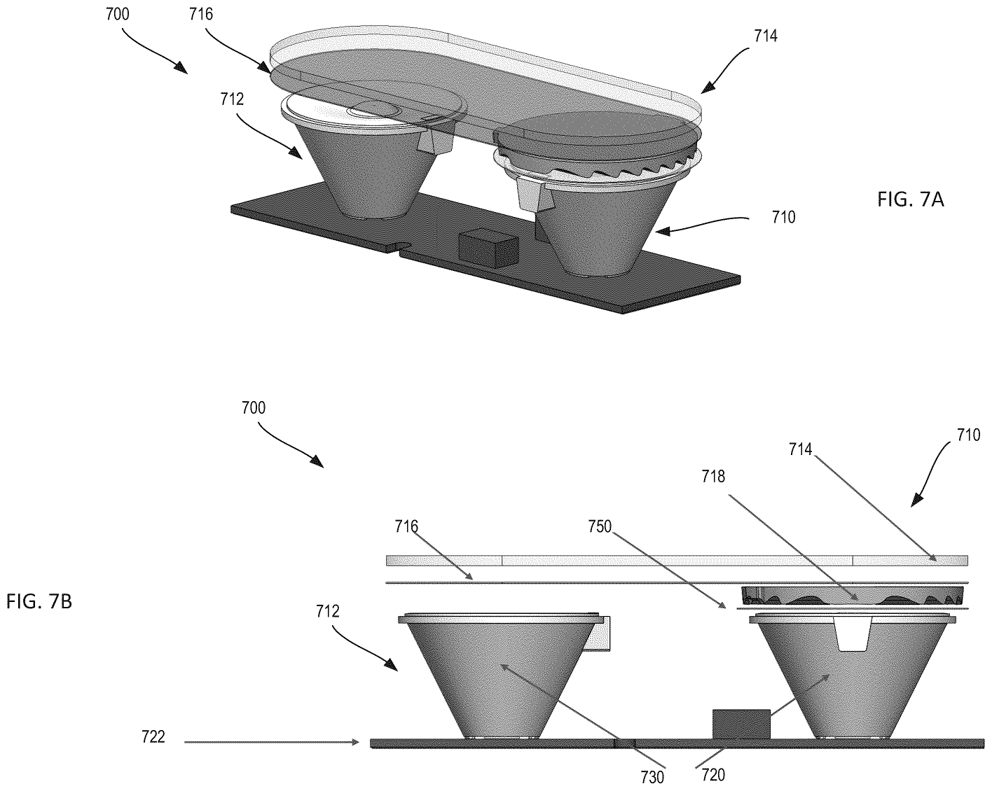

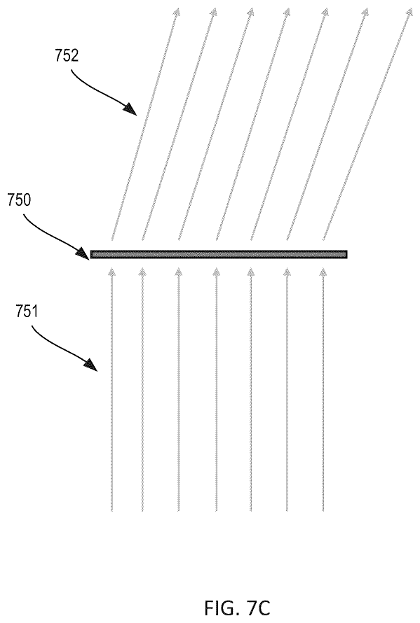

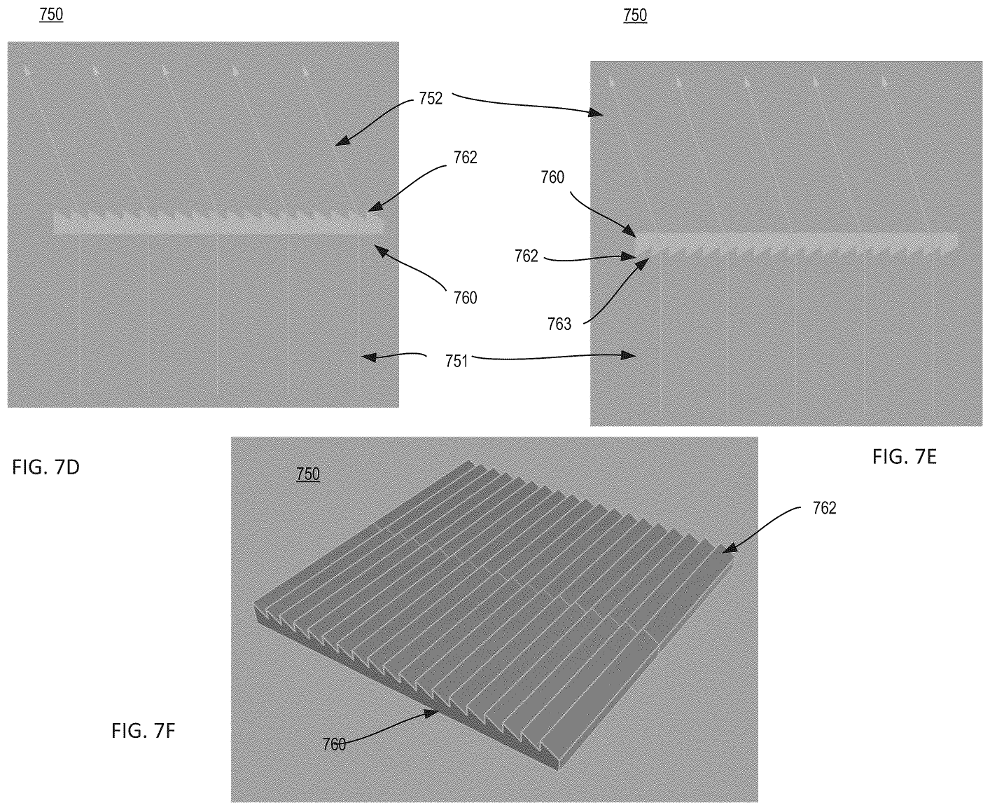

FIGS. 7A-7F illustrate a various views of a lighting fixture 700 consistent with another embodiment of the present disclosure. In the previous embodiments described above, a directionally linear gradient lighting effect is achieved using two (or more) light sources that are physically angled with respect to one another. In the present embodiment, and as described below, optical members are included with one (or more) of the light sources to effectively “bend” emitted light to achieve an angled separation of the respective peak light intensity between the light sources.

FIG. 7A illustrates a perspective of the lighting fixture 700 according to this embodiment. The lighting fixture 700 includes a first light source 710 generally configured to generate a first selected light color output (or color temperature output in the case of nominally “white” light), and a second light source 712 configured to generate a second selected light color output (or color temperature output in the case of nominally “white” light). The first light source 710 is “aimed” at a first region of a surface, e.g., a bottom region of a projection surface (e.g., wall, column, etc.). The second light source 712 is “aimed” at a second region of the projection surface, e.g., a top region of the wall, column, etc. A color gradient is formed on the surface of the wall/column, based on an optical angle between the first and second light sources 710, 712, a distance the light sources 710,712 are from the projection surface, and an intensity distribution of the light sources 710, 712, as will be described herein.

With continued reference to FIG. 7A, FIG. 7B illustrates a side view of the lighting fixture 700. The first light and second light sources 710/712 are coupled to a base unit 722 that generally includes electronic components to drive the lighting elements (not shown) associated with the light sources 710/712. The base unit 722 may be formed of, for example, PCB material, etc. Advantageously, in this embodiment, a single base unit 722 may be used to mount the light sources 710/712, thus providing cost savings and manufacturing efficiency, for example, compared to a dedicated base unit for each light source.

The lighting elements associated with the light sources 710/712 may include any known or after-developed lighting element, for example, RGB, RGBW, and RGBA type LED or clusters of LEDs, etc. The first light source 710 may also include a cone-shaped collimator 720 (e.g., color mixing collimator) generally configured to direct light from a lighting element disposed within the cone-shaped collimator 720 (not shown) toward the front of the cone-shaped collimator 720 into a narrow beam. The first light source 710 may also include other components to shape a light intensity and/or light direction of the light source. In one example embodiment, the first light source 710 may include an asymmetric refractor 718 disposed over the collimator 720 The asymmetric refractor 718 is generally configured to convert a narrow symmetric light beam generated by the lighting element and the collimator into a broad asymmetric light beam projected onto the bottom of the surface, as described above. The asymmetric refractor 718 may be formed of glass, plastic, etc., and may also be in a film format with micro features or formed (e.g. via injection molding or extrusion) with macro features.

The first light source 710 also includes a light bending optical layer 750 disposed between the opening of the cone-shaped collimator 720 and the asymmetric refractor 718. As described below, the light bending optical layer 750 is generally configured to optically “bend” light emitted from the collimator 720 so that the light intensity projected by the first light source 710 is angled with respect to the light intensity projected by the second light source 712 to generate, at least in part, the directionally linear gradient lighting effects described herein. In other embodiments, the optical function of the optical layer 750 could alternatively be integrally designed into a single optic structure combining the optical layer 750 and the collimator 720 into a single optics package, rather than being a separate structure.

The second light source 712 may be similarly configured as the first light source 710, and includes a cone-shaped collimator 730 coupled to the base unit 722 generally configured to direct light from a lighting element disposed within the cone-shaped collimator 730 (not shown) toward the front of the cone-shaped collimator 730 into a narrower beam. In some embodiments, the second light source 712 may omit an asymmetric refractor, since in this example the light source 712 is “aimed” at a region on the surface that is further away than the projected first light source 710.

The lighting fixture 700 may also include an elliptical diffuser 716 disposed over the first and second light sources 710/712, as illustrated. The diffuser 716 is generally configured to “spread” the light beam left-to-right (i.e., horizontally) along the surface. The diffuser 716 may be formed of glass, plastic, etc. In some embodiments, the diffuser 716 may be embodied, for example, as a diffusion film with micro-features, etc., and may be similar to diffuser 216 described above. The lighting fixture 700 may also include a cover lens 714 disposed over the elliptical diffuser 716. The cover lens 714 may be formed of glass, plastic, etc.

The light sources 710 and 712 are depicted in FIGS. 7A and 7B as being disposed on the base unit 722 in a horizontal “side-by-side” arrangement with respect to the lit surface. In other embodiments, the light sources 710/712 may be disposed in a front-back arrangement (e.g., as illustrated in FIGS. 4A, 4B and 4C) and/or an “offset” arrangement.

FIG. 7C illustrates a side view of the light bending optical layer 750 according to this embodiment. With continued reference to FIGS. 7A and 7B, the light bending optical layer 750 is generally formed as a planar structure, which may be formed of glass, plastic, etc. The light bending optical layer 750 is generally configured to “bend” incident light 751 (i.e., light emanating from the collimator 720) to form angled light 752 (i.e., light that has a peak intensity that is angled with respect to the surface of the optical layer 750).

FIGS. 7D, 7E and 7F illustrates various views of the light bending optical layer 750 according to embodiments. With continued reference to FIGS. 7A, 7B and 7C, the light bending optical layer 750 includes a plurality of prism structures 762 disposed on one surface of the layer 750. The prism structures 762 are disposed generally parallel to one another and have a prism angle 763 that is selected to cause a desired light bending angle 752 relative to the surface of the layer 750. An opposing side 760 of the layer 750 may be generally planar. In other embodiments, the optical function of the optical layer 750 could alternatively be integrally designed into a single optic structure combining the optical layer 750 and the collimator 720 into a single optics package, rather than being a separate structure.

In some embodiments, the lighting fixture 700 of FIGS. 7A-7F may be disposed in a housing structure, as described below.

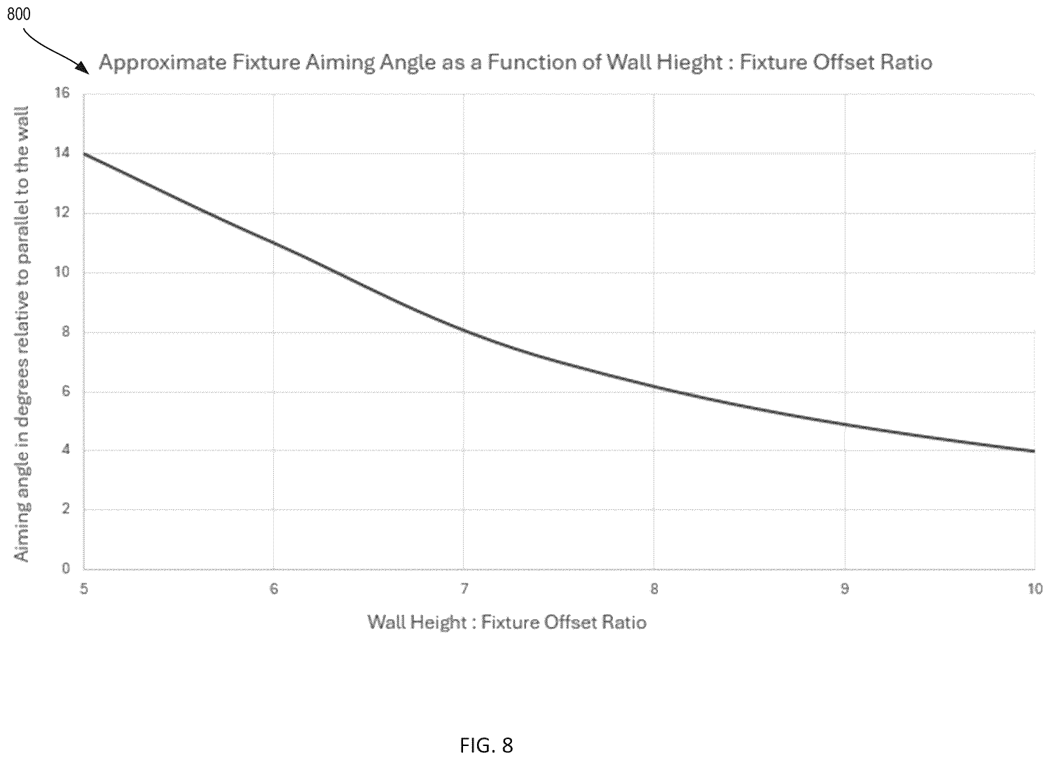

FIG. 8 illustrates a plot 800 of approximate global angle (e.g., angle 241 determination. The x-axis represents a ration of wall height to fixture distance from the wall (offset), and the y-axis represents the global angle (241) that the light fixture should be aimed (aiming angle) to achieve the color gradient effects described herein.

The plots shown in FIGS. 5B, 6 and the description thereof apply equally to the optically angled embodiments described above with reference to FIGS. 7A-7F. In addition, the “global” angle (241) described herein may be applied to the optically angled fixtures described herein.

FIGS. 9, 10, 11A and 11B illustrate various examples of lighting fixtures consistent with the optical offset embodiment shown in FIGS. 7A-7F. FIG. 9 illustrates one example lighting fixture 900 that includes a first pair of light sources 910A/912A and a second pair of light sources 910B/912B disposed within a pivotable housing structure 950. The first pair of light sources 910A/912A and a second pair of light sources 910B/912B are disposed “front to back” relative to one another and relative to the target lighting surface. Of course, while this embodiment illustrates two pairs of light sources 910A/912A and 910B/912B, in other embodiments, the housing 250 may be elongated to accommodate more light source pairs. The lighting fixture 900 of FIG. 9 is illustrated as being consistent with the physical angle offset between the light sources 910/912, as described above with reference to FIGS. 2A-2D. However, in other embodiments, each pair of light sources 910/912 may be similar to the light sources 710 and 712, i.e., the optically angled embodiments described above.

FIG. 10 illustrates another example lighting fixture 1000 that includes a pair of light sources 1010/1012 disposed within a pivotable housing structure 1050. The pair of light sources 1010/1012 are disposed “front to back” relative to one another and relative to the target lighting surface. The lighting fixture 1000 of FIG. 10 is illustrated as being consistent with the physical angle offset between the light sources 1010/1012, as described above with reference to FIGS. 2A-2D. However, in other embodiments, each pair of light sources 1010/1012 may be similar to the light sources 710 and 712, i.e., the optically angled embodiments described above.

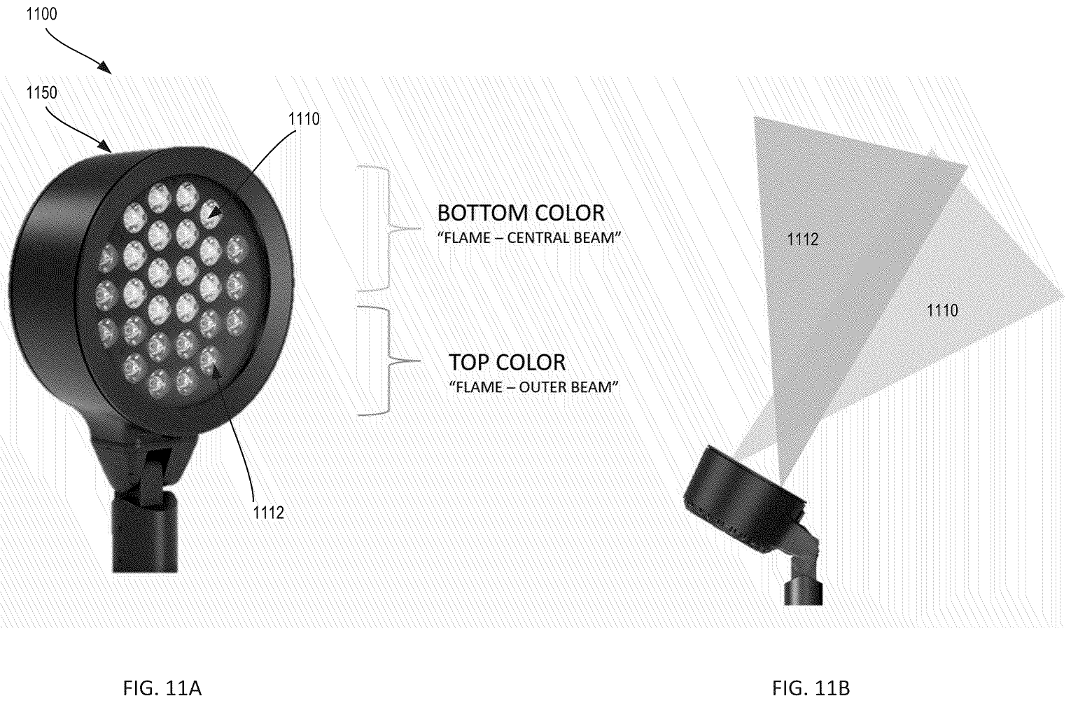

FIGS. 11A and 11B illustrate another example lighting fixture 1100. In this example, a first plurality of light sources 1110 and a second plurality of light sources 1112 are disposed within a generally circular housing 1150. The first plurality of light sources 1110 may be grouped together to form a first grouping of light sources, and the second plurality of light sources 1112 may be grouped together to form a second grouping of light sources. The first plurality of light sources 1110 are each similar to light source 710, described above, and the second plurality of light sources 1112 are each similar to light source 712, described above. In some embodiments, the first plurality of light sources 1110 and/or the second plurality of light sources 1112 may each include a single light source. The first and second plurality of light sources 1110/1112 are disposed in a coplanar manner within the housing 750. FIG. 11B illustrates the lighting effect of the first plurality of light sources 1110 and the second plurality of light sources 1112 to generate the smooth gradient lighting effect as described herein. The lighting fixture 1100 of FIG. 11 is illustrated as being consistent with the optically angled offset between the first plurality of light sources 1110 and the second plurality of light sources 1112, as described above with reference to FIGS. 7A-7F. However, in other embodiments, each pair of light sources 1110/1112 may be similar to the light sources 210 and 212, i.e., the physically angled embodiments described above.

While the foregoing embodiments have been described as generating a desired gradient effect using two light sources (or pairs of light sources), it will be understood by the teachings provided herein that the gradient effect may be achieved using any number of light sources, for example, a first light source generally directed at a bottom region of a target surface, a second light source generally directed at a top region of the target surface, and a third (or more) light source generally directed to a middle region of the target surface. In addition, while the foregoing embodiments describe in detail generating desirable gradient effects using two (or more) colors, the teachings of the present disclosure may be modified to provide a single-color effect on a projection surface. For example, if two light sources of the same color are used, a “color wash” gradient effect may be achieved in which the gradient effect is a luminous gradient effect rather than a color gradient. As a further example, two white light sources may be used to achieve a “whitewash” gradient effect on a projection surface (e.g., outside wall, side of building/structure, column, etc.).

Accordingly, in one embodiment the present disclosure provides a lighting fixture to illuminate a surface. The lighting fixture includes a first light source configured to generate a first selected light color output; and a second light source configured to generate a second selected light color output; wherein the first light source and the second light source are disposed adjacent to one another; and wherein the first light source to project the first selected light color output towards a first region of the surface and the second light source to project the second selected light color output towards a second region of the surface; and wherein a first peak intensity of the first light source and a second peak intensity of the second light source being angled with respect to one another to produce a selected color gradient on the surface.

In another embodiment, the present disclosure provides lighting fixture to illuminate a surface. The lighting fixture includes a housing; and a least a first pair of light sources disposed within the housing; wherein the first pair of light sources includes: a first light source configured to generate a first selected light color output; and a second light source configured to second selected light color output; wherein the first light source and the second light source are disposed adjacent to one another; and wherein the first light source to project the first selected light color output towards a first region of the surface and the second light source to project the second selected light color output towards a second region of the surface; and wherein a first peak intensity of the first light source and a second peak intensity of the second light source having an angle with respect to one another to produce a selected color gradient on the surface.

In another embodiment, the present disclosure provides A lighting fixture to illuminate a surface. The lighting fixture includes a housing; and a first plurality of light sources disposed within the housing, the first plurality of light sources comprising at least one first light source configured to generate a first selected light color output and grouped together to form a first grouping of light sources; a second plurality of light sources disposed within the housing, the second plurality of light sources comprising at least one second light source configured to generate a second selected light color output and grouped together to form a second grouping of light sources; wherein the first plurality of light sources and the second plurality of light sources being disposed within the housing in a generally coplanar manner with respect to each other; and wherein the first plurality of light sources to project the first selected light color output towards a first region of the surface and the second plurality of light sources to project the second selected light color output towards a second region of the surface; and wherein a first peak intensity of the first plurality of light sources and a second peak intensity of the second plurality of light sources having an angle with respect to one another to produce a selected color gradient on the surface.

As used herein, the terms “side”, “front”, “back”, “top”, “bottom”, “vertical”, “horizontal”, “left”, “right” etc. are provided as a descriptive aid, not as a limitation or specific orientation. While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A lighting fixture to illuminate a surface, the lighting fixture comprising:
a first light source configured to generate a first selected light color output; and
a second light source configured to generate a second selected light color output;
wherein the first light source and the second light source are disposed adjacent to one another; and wherein the first light source to project the first selected light color output towards a first region of the surface and the second light source to project the second selected light color output towards a second region of the surface; and wherein a first peak intensity of the first light source and a second peak intensity of the second light source having an angle with respect to one another to produce a selected color gradient on the surface.

2. The lighting fixture of claim 1, wherein the first and second light sources disposed horizontally adjacent to one another with respect to the surface.

3. The lighting fixture of claim 1, wherein the first and second light sources disposed front to back adjacent to one another with respect to the surface.

4. The lighting fixture of claim 1, wherein the angle between the first and second peak intensities occurs in a plane perpendicular to the projection surface and passing through the lighting fixture.

5. The lighting fixture of claim 4, wherein the angle between the first and second peak intensities is between 5 and 25 degrees (inclusive).

6. The lighting fixture of claim 1, wherein the first peak intensity is characterized by an asymmetric beam having a beam spread that is 50 degrees or greater as measured by a full width tenth max (FWTM) metric in a plane perpendicular to the projection surface and passing through the lighting fixture.

7. The lighting fixture of claim 1, wherein the second light source is characterized as having a beam spread of 25 degrees or less as measured using a full-width, half max (FWHM) metric in a plane perpendicular to the projection surface and passing through the lighting fixture.

8. The lighting fixture of claim 1, wherein the first and second light sources being physically angled with respect to one another; and wherein the first light source including a first optical assembly comprising:
a first collimator disposed over the first light source;
a first asymmetric refractor disposed over the collimator, the first asymmetric refractor to convert a beam of light from the collimator into a broader asymmetric beam of light;
a first elliptical diffuser disposed over the first asymmetric refractor, the first elliptical diffuser to broaden the first selected color light output horizontally along the surface;
and wherein:
the second lighting source including a second optical assembly comprising:
a second collimator disposed over the second light source; and
a second elliptical diffuser disposed over the second collimator, the second elliptical diffuser to broaden the second selected color light output horizontally along the surface.

9. The lighting fixture of claim 1, wherein the first and second light sources being optically angled with respect to one another; and wherein the first light source including a first optical assembly comprising:
a first collimator disposed over the first light source;
a light bending optical layer disposed over the first collimator, the light bending optical layer configured to optically bend light emitted from the collimator to achieve the optical angle with respect to the first and second light sources;
a first asymmetric refractor disposed over the light bending optical layer, the first asymmetric refractor to convert a beam of light from the collimator into a broader asymmetric beam of light;
a first elliptical diffuser disposed over the first asymmetric refractor, the first elliptical diffuser to broaden the first selected color light output horizontally along the surface;
and wherein the second lighting source including a second optical assembly comprising:
a second collimator disposed over the second light source; and
a second elliptical diffuser disposed over the second collimator, the second elliptical diffuser to broaden the second selected color light output horizontally along the surface.

10. The lighting fixture of claim 9, further comprising a base member, wherein the first and second optical assemblies being configured to mount to the base member.

11. The lighting fixture of claim 1, wherein the first and second light sources each include a light emitting diode (LED) or cluster of LED light sources.

12. The lighting fixture of claim 11, wherein the LED light sources are selected from Red, Green, Blue, White, Amber, RGB, RGBW, and RGBA type LED or clusters of LEDs light sources.

13. The lighting fixture of claim 1, wherein the selected color gradient is characterized by S-S-shaped curves representing percentages of the first color and second color projected onto the surface.

14. A lighting fixture to illuminate a surface, the lighting fixture comprising:
a housing; and
a least a first pair of light sources disposed within the housing; wherein the first pair of light sources includes:
a first light source configured to generate a first selected light color output; and
a second light source configured to generate a second selected light color output;
wherein the first light source and the second light source are disposed adjacent to one another; and wherein the first light source to project the first selected light color output towards a first region of the surface and the second light source to project the second selected light color output towards a second region of the surface; and wherein a first peak intensity of the first light source and a second peak intensity of the second light source having an angle with respect to one another to produce a selected color gradient on the surface.

15. The lighting fixture of claim 14, wherein the first and second light sources disposed horizontally adjacent to one another with respect to the surface.

16. The lighting fixture of claim 14, wherein the first and second light sources disposed front to back adjacent to one another with respect to the surface.

17. The lighting fixture of claim 14, wherein the first and second light sources being physically angled with respect to one another; and wherein the first light source including a first optical assembly comprising:
a first collimator disposed over the first light source;
a first asymmetric refractor disposed over the collimator, the first asymmetric refractor to convert a beam of light from the collimator into a broader asymmetric beam of light;
a first elliptical diffuser disposed over the first asymmetric refractor, the first elliptical diffuser to broaden the first selected color light output horizontally along the surface;
and wherein:
the second lighting source including a second optical assembly comprising:
a second collimator disposed over the second light source; and
a second elliptical diffuser disposed over the second collimator, the second elliptical diffuser to broaden the second selected color light output horizontally along the surface.

18. The lighting fixture of claim 14, wherein the first and second light sources being optically angled with respect to one another; and wherein the first light source including a first optical assembly comprising:
a first collimator disposed over the first light source;
a light bending optical layer disposed over the first collimator, the light bending optical layer configured to optically bend light emitted from the collimator to achieve the angle with respect to the first and second light sources;
a first asymmetric refractor disposed over the light bending optical layer, the first asymmetric refractor to convert a beam of light from the collimator into a broader asymmetric beam of light;
a first elliptical diffuser disposed over the first asymmetric refractor, the first elliptical diffuser to broaden the first selected color light output horizontally along the surface;
and wherein the second lighting source including a second optical assembly comprising:
a second collimator disposed over the second light source; and
a second elliptical diffuser disposed over the second collimator, the second elliptical diffuser to broaden the second selected color light output horizontally along the surface.

19. The lighting fixture of claim 18, further comprising a base member, wherein the first and second optical assemblies being configured to mount to the base member.

20. The lighting fixture of claim 14, wherein the first and second light sources each include a light emitting diode (LED) or cluster of LED light sources.

21. A lighting fixture to illuminate a surface, the lighting fixture comprising:
a housing; and
a first plurality of light sources disposed within the housing, the first plurality of light sources comprising at least one first light source configured to generate a first selected light color output and grouped together to form a first grouping of light sources;
a second plurality of light sources disposed within the housing, the second plurality of light sources comprising at least one second light source configured to generate a second selected light color output and grouped together to form a second grouping of light sources;
wherein the first plurality of light sources and the second plurality of light sources being disposed within the housing in a generally coplanar manner with respect to each other; and
wherein the first plurality of light sources to project the first selected light color output towards a first region of the surface and the second plurality of light sources to project the second selected light color output towards a second region of the surface; and wherein a first peak intensity of the first plurality of light sources and a second peak intensity of the second plurality of light sources having an angle with respect to one another to produce a selected color gradient on the surface.

22. The lighting fixture of claim 21, wherein the first plurality of light sources and the second plurality of light sources being optically angled with respect to one another; and wherein each of the first light plurality of light sources including a first optical assembly comprising:
a first collimator disposed over the first light source;
a light bending optical layer disposed over the first collimator, the light bending optical layer configured to optically bend light emitted from the collimator to achieve the angle with respect to the first and second light sources;
a first asymmetric refractor disposed over the light bending optical layer, the first asymmetric refractor to convert a beam of light from the collimator into a broader asymmetric beam of light;
a first elliptical diffuser disposed over the first asymmetric refractor, the first elliptical diffuser to broaden the first selected color light output horizontally along the surface;
and wherein the second plurality of light sources each including a second optical assembly comprising:
a second collimator disposed over the second light source; and
a second elliptical diffuser disposed over the second collimator, the second elliptical diffuser to broaden the second selected color light output horizontally along the surface.

23. The lighting fixture of claim 21, further comprising a base member, wherein the optical assemblies being configured to mount to the base member.

24. The lighting fixture of claim 21, wherein the first and second light sources each include a light emitting diode (LED) or cluster of LED light sources.
